(19) United States
(12) Patent Application Publication
(10) Pub. No.: US 2022/0338164 A1
(43) Pub. Date: Oct. 20, 2022

(54) COOPERATIVE ACCESS FRONTHAUL (CAF) ATSC BROADCAST USING LDM FOR SFN DENSIFICATION

(71) Applicant: Sinclair Broadcast Group, Inc., Hunt Valley, MD (US)

(72) Inventors: Michael J. SIMON, Frederick, MD (US); Louis Herbert LIBIN, Woodmere, NY (US); Mark A. AITKEN, Parkton, MD (US)

(73) Assignee: Sinclair Broadcast Group, Inc., Hunt Valley, MD (US)

(21) Appl. No.: 17/659,692

(22) Filed: Apr. 19, 2022

Related U.S. Application Data
(60) Provisional application No. 63/177,101, filed on Apr. 20, 2021.

(51) Int. Cl. H04W 72/00; H04W 4/06; H04N 21/438; H04N 21/2383

(52) U.S. Cl. CPC H04W 72/005; H04W 4/06; H04N 21/4382; H04N 21/2383; H04W 88/085

(57) ABSTRACT

Some aspects of this disclosure are direct to a system that includes a first scheduler configured to receive an input packet and generate a first packet to be transmitted using a first radio unit (RU). The system further includes a second scheduler configured to receive the first packet from the first scheduler and generate a second packet. The second packet is to be transmitted using a second RU. The system further includes a first fronthaul operated using evolved Common Public Radio Interface (eCPRI) protocol and configured to direct the first packet to the first RU to be transmitted on a first channel having a first frequency. The system further includes a second fronthaul operated using the eCPRI protocol and configured to direct the second packet to the second RU to be transmitted on a second channel having a second frequency different from the first frequency.

### CROSS-REFERENCE TO RELATED APPLICATIONS

This application claims priority to U.S. Provisional Patent Application No. 63/177,101 titled “ATSC 3.0 Enabled LDM-SFN Densification and Local Data Insertion in Broadcast Internet Era” filed on Apr. 20, 2021, which is hereby incorporated by reference in its entirety for all purposes.

This application is related to U.S. Provisional Patent Application No. 63/306,333 titled “ATSC 3.0 and Non-3.0 Broadcast Co-exist Aligned O-RAN” filed on Feb. 3, 2022; U.S. Provisional Patent Application No. 63/149,025 titled “ATSC 3.0 Multicast-Broadcast Intelligent RAN Topologies” filed on Feb. 12, 2021; U.S. patent application Ser. No. 17/670,233 titled “ATSC 3.0 Multicast-Broadcast Intelligent RAN Topologies” filed on Feb. 11, 2022; U.S. patent application Ser. No. 16/808,996 titled “Enabling Efficient Deterministic Virtualized Broadcast Spectrum Sharing and Usage Validation” filed on Mar. 4, 2020 and published as U.S. Patent Application Publication No. 2020-0288325-A1 published on Sep. 10, 2020; and U.S. Pat. No. 10,951,334 titled “Broadcast relaying via cooperative multi-channel transmission” issued on Mar. 16, 2021, all of which are herein incorporated by reference in their entirety for all purposes.

### BACKGROUND

In 2018, the Federal Communications Commission (FCC) adopted Advanced Television Systems Committee (ATSC) 3.0 broadcast standard and permitted voluntary implementation by licensed broadcasters. The FCC rules permit broadcasters to share their licensed 6 MHz channels (spectrum) and infrastructure and enter into new innovative business agreements using their shared spectrum. In December 2020, the FCC also adopted a Report and Order to promote “Broadcast Internet” innovation as part of the market driven transition to ATSC 3.0.

The FCC Rules permit a broadcast topology known as a Single Frequency Networks (SFN) to improve reliability and types of service. The SFN topology uses multiple (e.g., N) synchronized broadcast transmitters operating on the same single frequency and emitting coherent signals under control of a centralized gateway or SFN controller.

Each SFN transmitter requires a communications link termed a fronthaul currently using fiber, microwave, or satellite to establish the link from centralized gateway or SFN controller to each transmitter site in SFN. This fronthaul link provides data or content for broadcast and the timing and control to enable and maintain coherent SFN transmitters.

### BRIEF SUMMARY

The aspects of this disclosure provide flexibility to use shared broadcast spectrum frequencies cooperatively to provide the fronthaul link to SFN transmitters sites over a large geographic area while still providing independent broadcast services on those cooperative spectrum frequencies. This opens a flexible economic method termed Cooperative Access Fronthaul (CAF) to establish SFN transmitter sites over a wide area including indoors at malls and other venues for consumers opening new business models.

The CAF is enabled on the donor broadcast frequency using ATSC 3.0 layered division multiplexing (LDM) technology. Two methods of CAF are disclosed, the first based on ATSC 3.0 A/324 standard and Studio to Transmitter Link Transport Protocol (STLTP) that uses traditional monolithic hardware appliances. The second CAF method uses the evolved Common Public Radio Interface (eCPRI) protocol and is aligned with the cloud-native methods used in 5G Open Radio Access Network (RAN). Each CAF method is disclosed and use case examples are given including the benefits of intelligent RAN and cloud automation using CAF eCPRI method.

The A/324 CAF method in which the SFN is provisioned manually is compared to eCPRI CAF method aligned with 5G Open RAN, in which the SFN is provisioned using cloud-native automation for self-organizing network (SON) functionality and use cases.

This is in line with FCC rules that permit broadcasters to share their licensed 6 MHz channels (spectrum) and infrastructure and enter into new innovative business agreements using their shared spectrum.

Some aspects of this disclosure are direct to a system that includes a first scheduler configured to receive an input packet and generate a first packet (based on the input packet) to be transmitted using a first radio unit (RU). The system further includes a second scheduler configured to receive the first packet from the first scheduler and generate a second packet based on the first packet. The second packet is to be transmitted using a second RU. The system further includes a first fronthaul operated using evolved Common Public Radio Interface (eCPRI) protocol and configured to direct the first packet to the first RU to be transmitted on a first channel having a first frequency. The system further includes a second fronthaul operated using the eCPRI protocol and configured to direct the second packet to the second RU to be transmitted on a second channel having a second frequency different from the first frequency.

In some examples, the second RU is configured to transmit the second packet over an enhanced layer of a layer division multiplexed (LDM) packet.

In some examples, the system further includes a third scheduler configured to receive the first packet from the first scheduler and generate a third packet, wherein the third packet is to be transmitted using a third RU. The system can also include a third fronthaul operated using the eCPRI protocol and configured to direct the third packet to the third RU to be transmitted on a third channel having a third frequency different from the first frequency and the second frequency.

In some examples, the third RU is configured to transmit the third packet over the enhanced layer of a second LDM packet. In some examples, the second scheduler is configured to use a first portion of the first packet to generate the second packet. The third scheduler is configured to use a second portion of the first packet to generate the third packet.

In some examples, the first and second schedulers are part of a cloud aligned with Open Radio Access Network (O-RAN) cloud-native principles. The system can further include a plurality of Single Frequency Network (SFNs) and an O-RAN intelligence system configured to automate provision of the plurality of SFNs.

In some examples, the O-RAN intelligence system includes a Self-Organizing Network (SON), a Service Management Orchestration (SMO), and a Non-Real-time RAN Intelligent Control (MC).

In some examples, the system further includes an automation platform configured to receive one or more design parameters associated to the plurality of SFNs and configured to send the one or more design parameters to the O-RAN intelligence system. The SON can be configured to direct the first scheduler to start SFN provisioning. The first scheduler can be configured to generate and transmit a one-way timing measurement packet using the first and second fronthauls.

Some aspects of this disclosure are directed to a non-transitory computer-readable medium that includes instructions stored thereon that, when executed by at least one computing device, cause the at least one computing device to perform operations. The operations can include receiving, using a first scheduler, an input packet and generating, using the first scheduler, a first packet (based on the input packet) to be transmitted using a first radio unit (RU). The operations can further include receiving, using a second scheduler, the first packet from the first scheduler and generating, using the second scheduler, a second packet based on the first packet. The second packet is to be transmitted using a second RU. The operation can also include directing, using a first fronthaul operated using evolved Common Public Radio Interface (eCPRI) protocol, the first packet to the first RU to be transmitted on a first channel having a first frequency. The operations can also include directing, using a second fronthaul operated using the eCPRI protocol, the second packet to the second RU to be transmitted on a second channel having a second frequency different from the first frequency.

Some aspect of this disclosure are related to a system including a first Advanced Television Systems Committee (ATSC) scheduler configured to receive an input packet and generate a first packet (based on the input packet) to be transmitted using a first ATSC exciter. The system can also include a second ATSC scheduler configured to receive the first packet from the first ATSC scheduler and generate a second packet based on the first packet. The second packet is to be transmitted using a second ATSC exciter. The system can further include a first Studio to Transmitter Link Transport Protocol (STLTP) fronthaul configured to direct the first packet to the first ATSC exciter to be transmitted on a first channel having a first frequency and a second STLTP fronthaul configured to direct the second packet to the second ATSC exciter to be transmitted on a second channel having a second frequency different from the first frequency.

In some examples, the second ATSC exciter is configured to transmit the second packet over an enhanced layer of a layer division multiplexed (LDM) packet.

### BRIEF DESCRIPTION OF THE DRAWINGS

The accompanying drawings, which are incorporated herein and form part of the specification, illustrate the presented disclosure and, together with the description, further serve to explain the principles of the disclosure and enable a person of skill in the relevant art(s) to make and use the disclosure. In the accompanying drawings, structures are illustrated that, together with the detailed description provided below, describe exemplary aspects of the claimed invention. Elements shown as a single component may be replaced with multiple components, and elements shown as multiple components may be replaced with a single component. The drawings are not to scale, and the proportion of certain elements may be exaggerated for illustration.

FIG. 1 illustrates an exemplary block diagram showing both methods disclosed using either A/324 STLTP or eCPRI protocols to enable cooperative access fronthaul (CAF) using LDM for flexible single frequency network (SFN) densification, according to some aspects of this disclosure.

FIG. 2 illustrates an exemplary block diagram showing A/324 standard and STLTP for fronthaul to implement the ATSC 3.0 broadcast physical layer, according to some aspects of this disclosure.

FIG. 3 illustrates a Layer Division Multiplex (LDM) method used to combine two signals together in the power domain and transmit using same OFDM frequency and time resources but separated in power domain, according to some aspects of this disclosure. The broadcast LDM receiver recovers both signals and the equations shown are used to determine signal to noise after combining, according to some aspects of this disclosure.

FIG. 4 illustrates LDM configurations (Mod Cod, Injection level) used with application of the equations of FIG. 3 for the two signals combined in power domain, according to some aspects of this disclosure.

FIG. 5 illustrates example of the STLTP method for CAF using LDM with one CAF donor transmitter RF 2 for providing fronthaul for SFN densification on RF1, according to some aspects of this disclosure.

FIG. 6 illustrates ATSC 3.0 and Non-3.0 co-existence with dynamic spectrum sharing using eCPRI fronthaul, according to some aspects of this disclosure. Aligned Open RAN cloud principles and providing broadcast slices with a virtual frame reception paradigm are also disclosed.

FIG. 7 illustrates an exemplary block diagram using eCPRI for fronthaul to implement ATSC 3.0 and ATSC X.X co-existence of intelligent RAN broadcast physical layer, according to some aspects of this disclosure.

FIG. 8 illustrates example intelligent RAN eCPRI method of CAF using LDM with CAF donor transmitter RF 2 for providing fronthaul for SFN densification on RF1, according to some aspects of this disclosure.

FIG. 9 illustrates example broadcast virtual frames intelligent RAN eCPRI method of CAF using LDM for CAF on donor RF2 and RF 3 transmitters for flexible single frequency network (SFN) densification on RF1, according to some aspects of this disclosure.

FIG. 10 illustrates example intelligent RAN eCPRI method of CAF using LDM on CAF donor transmitter RF 2 and RF 3 for providing fronthaul SFN densification on RF1, according to some aspects of this disclosure.

FIG. 11 illustrates example SFN densification using intelligent RAN eCPRI method 0f CAF using LDM on CAF donor transmitter RF 2 and RF 3 for providing fronthaul SFN densification on RF1, according to some aspects of this disclosure.

FIG. 12 illustrates example SFN densification using intelligent RAN eCPRI method of CAF using LDM on CAF donor transmitter RF 2 and RF 3 for providing fronthaul SFN densification on RF1 Indoors with local data broadcast slice insertion, according to some aspects of this disclosure.

FIG. 13 illustrates example SFN infrastructure on demand using intelligent RAN eCPRI method of CAF using LDM on CAF donor transmitter RF 2 and RF 3 for providing fronthaul and SFN densification on RF 1 at popular events venues, according to some aspects of this disclosure.

### DETAILED DESCRIPTION

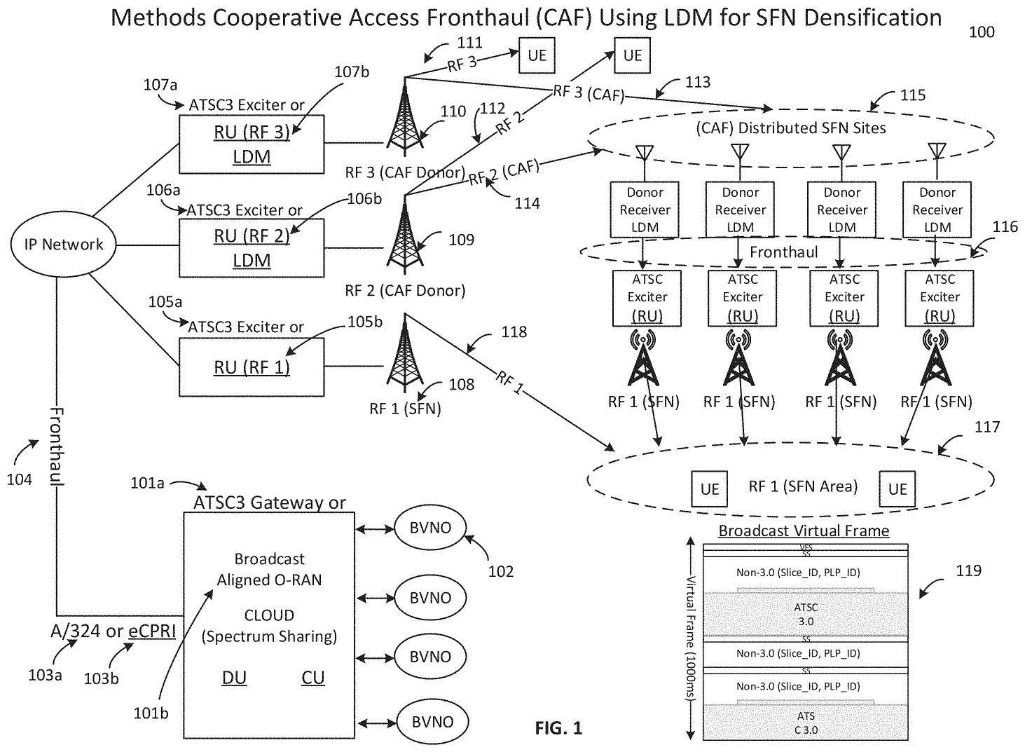

FIG. 1 illustrates an exemplary block diagram 100 showing both methods disclosed using either ATSC A/324 STLTP or eCPRI protocols to enable cooperative access fronthaul (CAF) using LDM for flexible single frequency network (SFN) densification, according to some aspects of this disclosure.

The first CAF method includes using ATSC 3.0 gateway 101a. ATSC 3.0 gateway 101a can be a monolithic hardware, which includes a scheduler. ATSC 3.0 gateway 101a can use fronthaul 104 to connect to an IP network using A/324 (STLTP) method 103a of the CAF.

The second method includes broadcast cloud aligned O-RAN 101b with schedulers, which can use fronthaul 104 to connect to the IP network. The second method uses eCPRI method 103b CAF for fronthaul 104 and uses spectrum sharing for multiple (e.g., N) broadcast virtual network operators (BVNO) 102. In some examples, broadcast cloud aligned O-RAN 101b can include a distributed unit (DU) and a centralized unit (CU).

The fronthaul 104 using A/324 (STLTP) method 103a directs data, content, parameters, etc. via the IP network to ATSC 3 exciter on RF 1 105a for use with RF 1 SFN 108. The fronthaul 104 using A/324 (STLTP) method 103a also directs data, content, parameters, etc. via the IP network to ATSC 3 exciter with LDM 106a on RF 2 CAF donor transmitter 109. The fronthaul 104 using A/324 (STLTP) method 103a also directs data, content, parameters, etc. via the IP network to ATSC 3 exciter with LDM 107a to RF 3 CAF donor transmitter 110.

The fronthaul 104 using eCPRI method 103b directs data, content, parameters, etc. via the IP network to radio unit (RU) aligned O-RAN on RF 1 105b for use RF 1 SFN 108. The fronthaul 104 using eCPRI method 103b also directs data, content, parameters, etc. via the IP network to RU with LDM 106b on RF 2 CAF donor transmitter 109. The fronthaul 104 using eCPRI method 103b is also sent via the IP network to and RU with LDM 107b to RF 3 CAF donor transmitter 110.

According to some aspects, radio frequency (RF) 1 is directed to frequency links, frequency bands, or frequency channels different from RF 2 and/or RF 3. According to some aspects, RF 2 is directed to frequency links, frequency bands, or frequency channels different from RF 1 and/or RF 3. According to some aspects, RF 3 is directed to frequency links, frequency bands, or frequency channels different from RF 1 and/or RF 2,

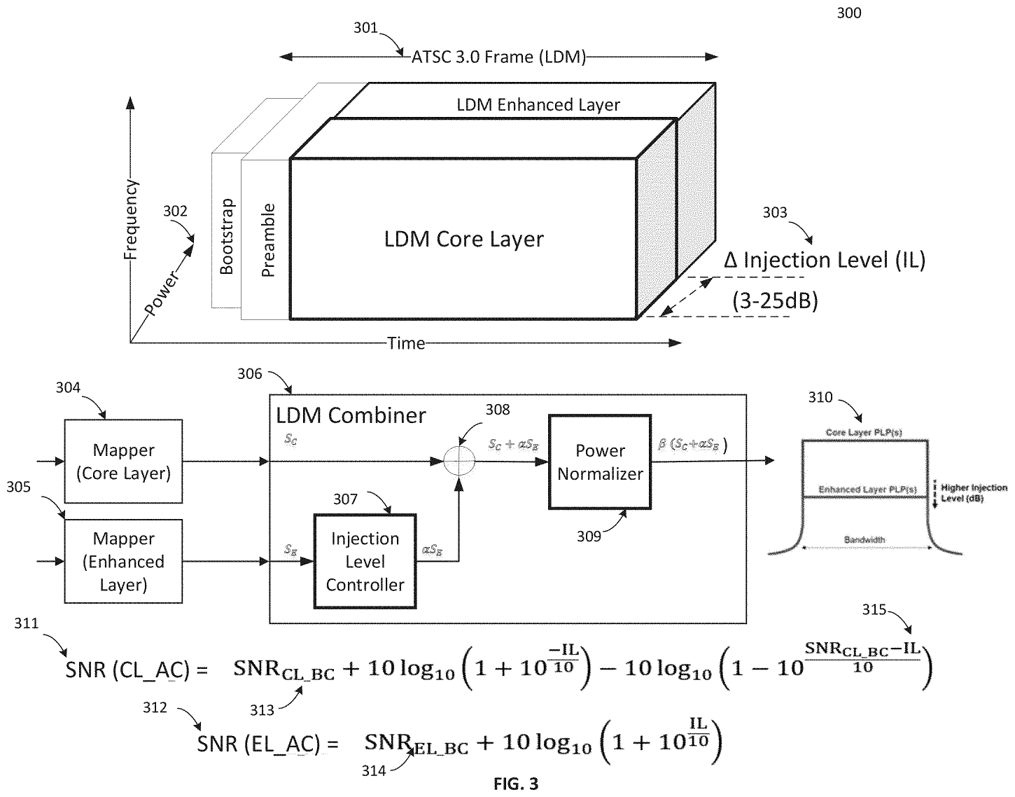

For both methods, RF 2 donor transmitter 109 using LDM (as discussed with respect to FIG. 3) transmits signal 112 to UE for independent services and CAF signal 114 to distributed SFN sites 115 with LDM receivers used to recover the CAF signal using LDM 300. For both methods, RF 3 donor transmitter 110 using LDM transmits signal 111 to UE for independent services and CAF signal 113 signal to the distributed SFN sites 115 with LDM receivers used to recover CAF using LDM 300.

As will be discussed below, the CAF distributed SFN sites 115 have donor receivers LDM and fronthaul is recovered at 116. The recovered fronthaul is input ATSC 3 exciter or RU for the SFN RF 1 transmitters, which produce coherent symbols in SFN area 117 for UE along with RF 1 SFN transmitter 108 and its coherent symbols in signal 118 arriving on RF 1.

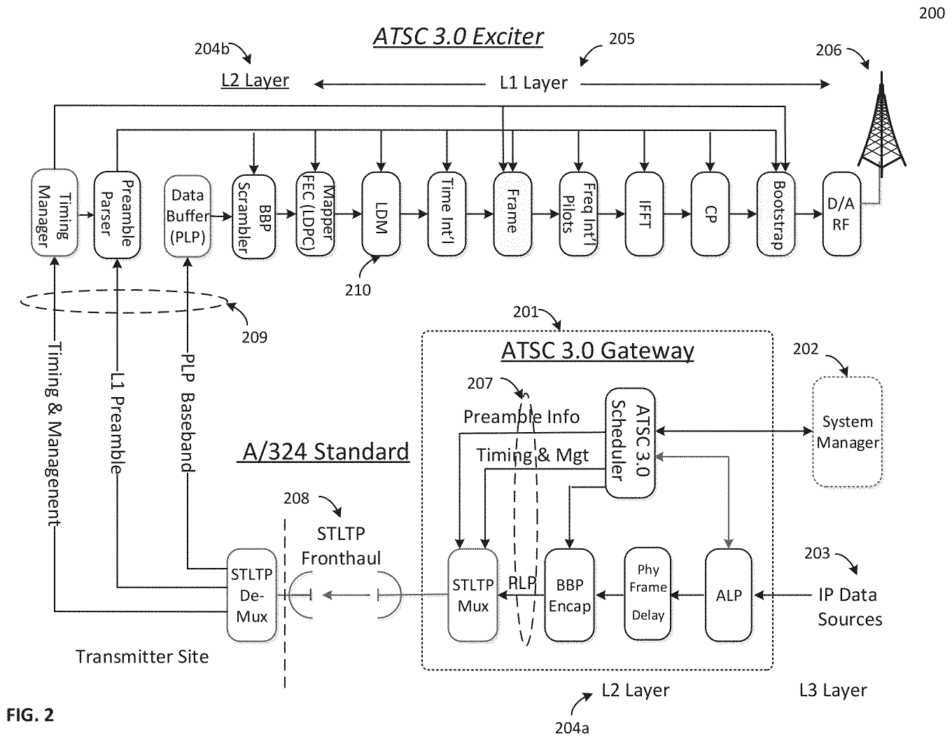

FIG. 2 illustrates an exemplary block diagram of system 200 showing A/324 standard and STLTP for fronthaul to implement the ATSC 3.0 broadcast physical layer, according to some aspects of this disclosure. The ATSC 3.0 gateway 201 has an scheduler controlled by system manager 202 as defined in A/324 standard. Layer 3 IP data content 203 enters ATSC 3.0 gateway 201. Portion of layer 2 of IP data content 203 is processed in ATSC 3.0 gateway 201 with remaining portion L2 layer 204b and L1 layer 205 are processed at the transmitter site in the ATSC 3 exciter. The scheduler of ATSC 3.0 gateway 201 sends PLP data and signaling and timing and management control 207 over the STLTP fronthaul 208 to transmitter site where PLP data and signaling and timing and management control 207 is recovered at 209 at the transmitter site. The PLP data and signaling and timing and management control 207 signaling and timing management establish SFN coherent symbols for multiple (e.g., N) SFN transmitters with only one transmitter shown in system 200.

Using recovered PLP data and signaling and timing and management control 209, the broadcast baseband frame is built, which includes LDM 210 (option) that is used for CAF donor transmitters to be discussed with respect to FIG. 3. A frame is then converted to RF signal 206 as shown and is broadcast. It should be appreciated that system 200 is realized using monolithic hardware, which is in contrast to the eCPRI method using cloud methodology 700, according to some aspects of this disclosure.

FIG. 3 illustrates block diagram 300 for Layer Division Multiplex (LDM) used in broadcast frame 301, according to some aspects of this disclosure. According to some examples, LDM combiner 306 is configured to combine two signals a core layer (CL) signal generated by CL mapper 304 and enhanced layer (EL) signal generated by EL mapper 305 in the power domain 302. LDM combiner 306 then uses same OFDM frequency and time resources 310 but with the signals multiplexed in the power domain 302.

The CL signal generated by CL mapper 304 is transmitted with most transmission power (e.g., with a transmission power more than the transmission power of the EL signal). The EL signal generated by EL mapper 305 is injected using injection level controller 307. The output of injection level controller 307 and the CL signal from CL mapper 304 are combined at 308 to generate a combine signal. After combing, the power of the combined signal is normalized using power normalizer 309 to maintain the same average power 310 as shown. The injection level of the EL signal at injection level controller 307 can be varied from 3-25 dB 303 below the CL signal.

The resulting SNR (CL_AC) of the core layer after LDM combiner 306 is given by equation 311 with main variables SNR (CL_BC) core layer before combining the CL signal and injection level used as 303 as shown in equation 315.

The resulting SNR (EL_AC) enhanced layer after LDM combiner 306 is given by equation 312 with main variables SNR (EL_BC) core layer before combining the EL signal and injection level used 303 as shown in equation. Examples of using these equations will be discussed below with respect to some aspects of this disclosure. The donor CAF transmitters will carry independent signals using (CL) and injected below (EL) will be used for CAF fronthaul using either STLTP or eCPRI method, according to some aspects of this disclosure. The receiver can receive (CL) without any special processing as LDM combiner 306 only adds noise (CL) 311 and is agnostic to the EL signal, according to some aspects. A LDM aware receiver receives EL signal, which has degradation in SNR equation 312 and recovers the CAF fronthaul.

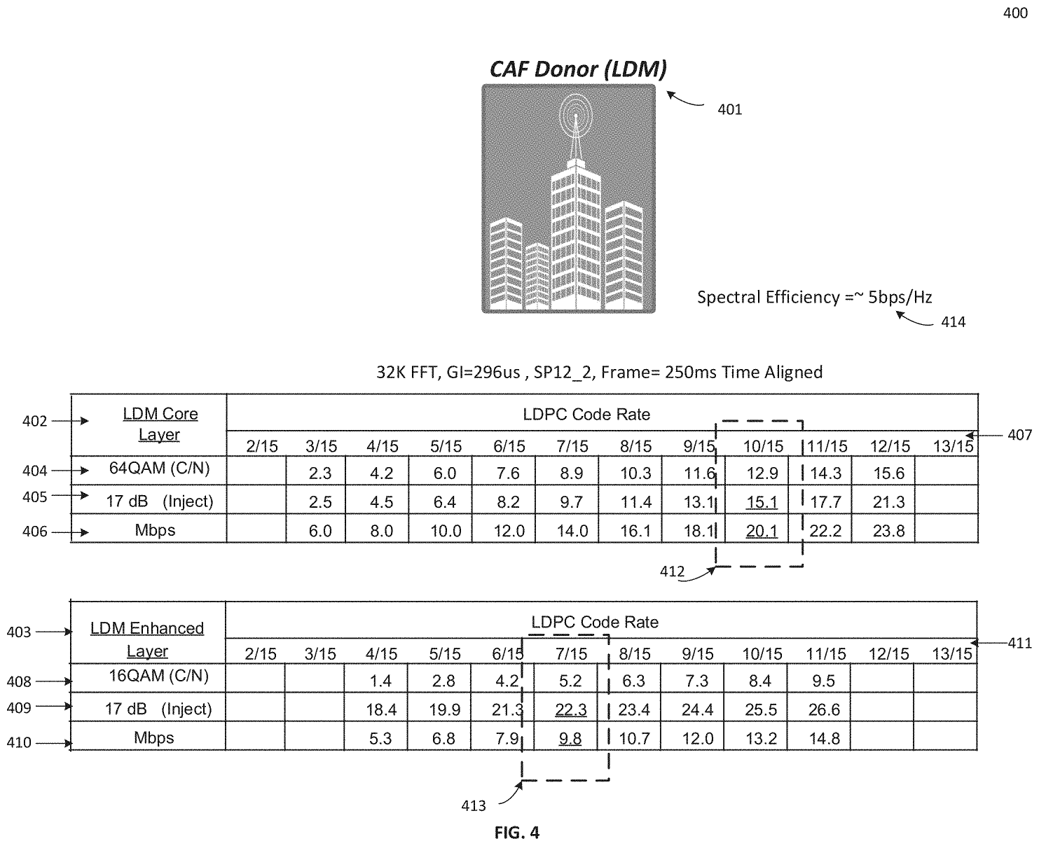

FIG. 4 illustrates exemplary block diagram 400 including CAF donor transmitter using LDM 401, according to some aspects of this disclosure. The LDM configurations core layer 402 uses equation 311 of FIG. 3 with Mod 404, Coding 407, Injection level 405, and capacity Mbps 406, according to some aspects.

The LDM configurations enhanced layer 403 uses equation 312 with Mod 408, Coding 411, Injection level 409, and capacity Mbps 410, according to some aspects. The selection for the examples in this disclosure for CAF donor transmitter is shown for core layer 412 and enhanced layer 413. However, the aspects of this disclosure are not limited to these examples,

According to some examples, the selection 412, 413 has an exceptionally good spectrum efficiency of 20.1 Mbps+9.8 Mbps=29.9 Mbps ˜5.0 bits/s/Hz. The CL SNR degradation is 15.1−12.9=2.2 dB because of equation 311 of FIG. 3. The EL SNR degradation is 22.3−5.2=17.1 dB because of equation 312 of FIG. 3 and is received at distributed SFN sites donor LDM receiver with professionally installed directional antenna with gain in examples to be discussed.

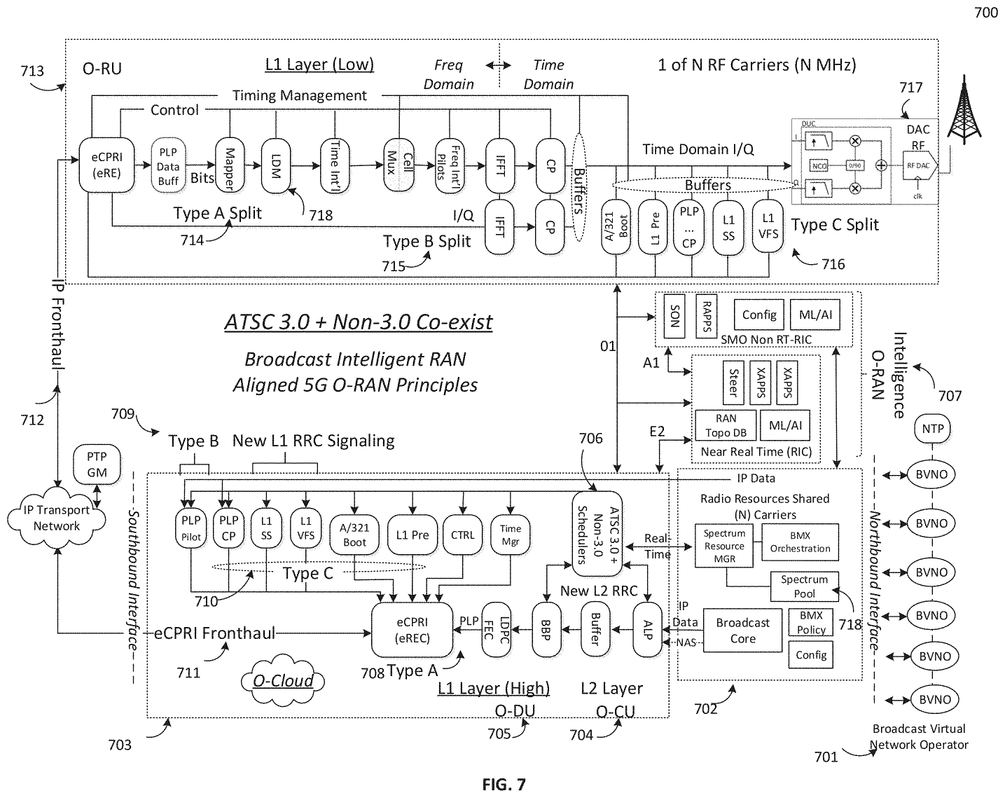

According to some aspects, transmitters are part of spectrum sharing 700 of FIG. 7 with OFDM resources in spectrum pool 718 of (N) broadcast virtual network operators 701 being shared under policy and SLA with all resources usage accounted.

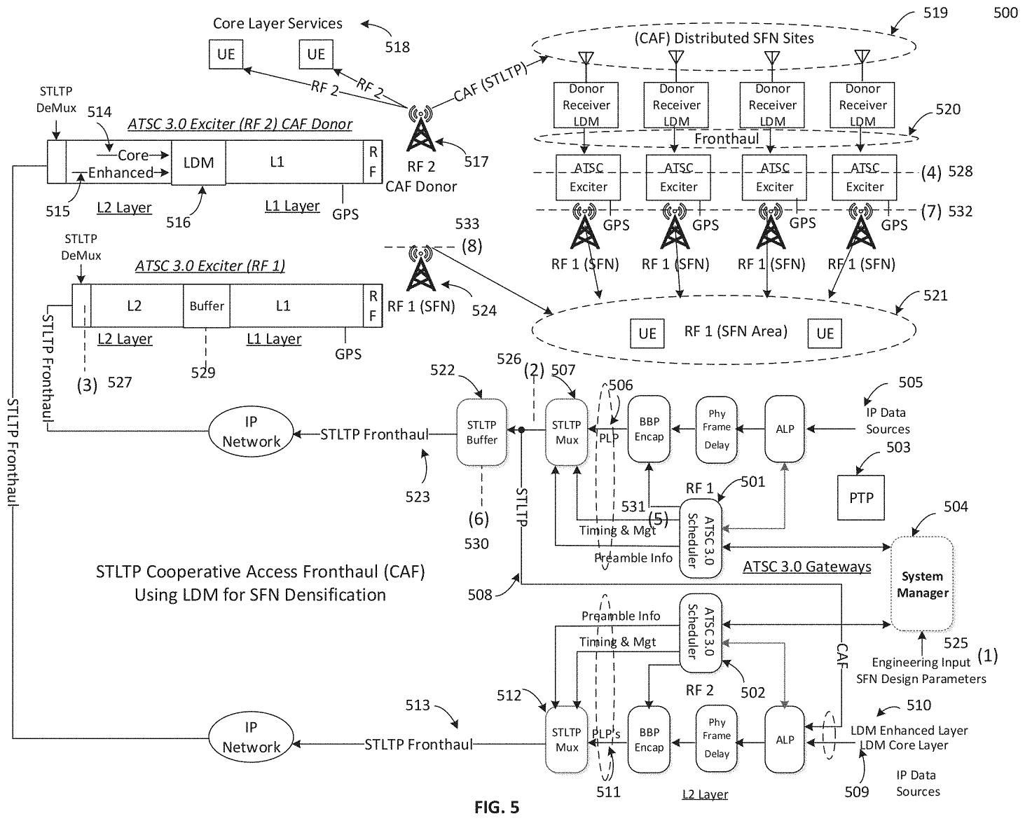

FIG. 5 illustrates system 500 as an example of STLTP method CAF using LDM with one CAF donor transmitter RF 2 517 for providing fronthaul for SFN densification in area on RF 1 521, according to some aspects. Two ATSC 3.0 gateways with RF1 scheduler 501 and RF 2 scheduler 502 are shown configured by system manager 504 with PTP reference 503.

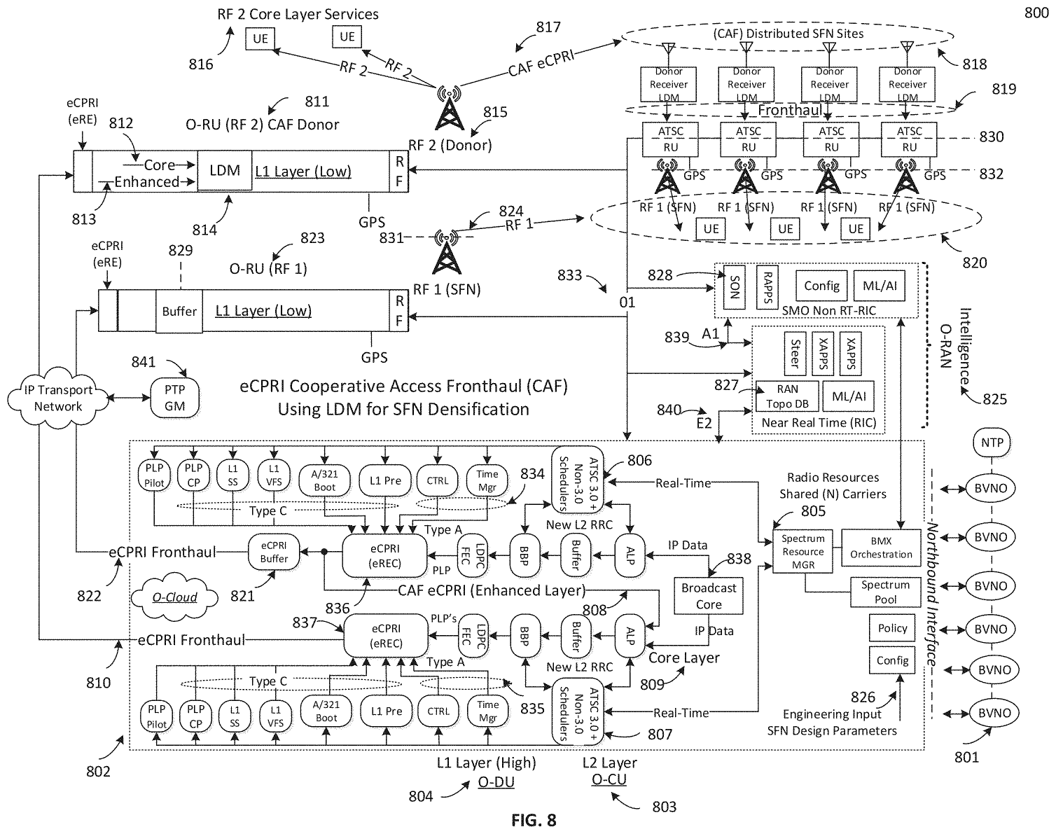

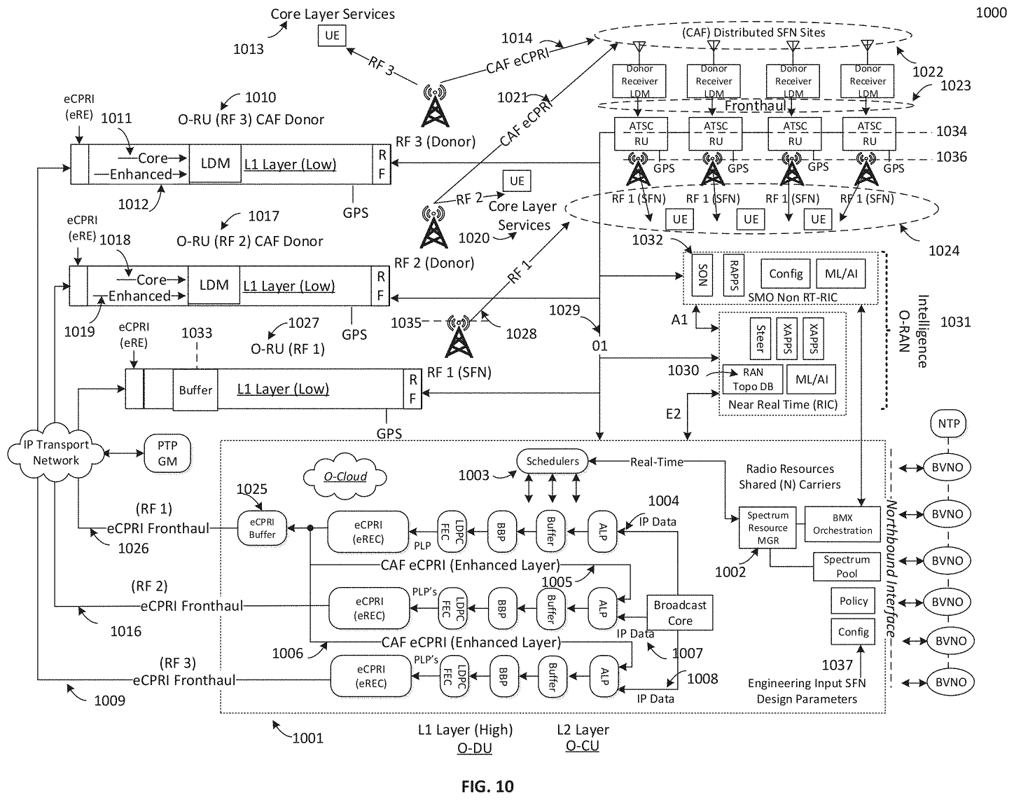

IP data sources 505 enter ATSC 3.0 gateway and scheduler RF 1 501. The scheduler RF 1 501 generates the PLP and timing management control and preamble info 506 combined in STLTP Mux 507 to control ATSC 3.0 exciter RF1 SFN 524. The STLTP is delayed in STLTP buffer 522 before sending STLTP fronthaul 523. To provision SFN, engineers 525 interact with system manager 504 to manually provision, according to some aspects. As discussed with respect to FIGS. 8 and 10, using eCPRI method cloud automation is used to provision and monitor SFN.

A second output of STLTP Mux 507 is sent as STLTP CAF 508 as input to scheduler RF 2 502 and serves as LDM enhanced layer signal 510 for RF 2 CAF donor 517. The LDM core layer signal 509 enters RF 2 scheduler 502 for RF 2 transmitter for the independent services RF 2 518 using LDM discussed above with respect to FIG. 3.

The scheduler RF 2 502 generates the PLP and timing management control and preamble info 511 combined in STLTP Mux 512 to control ATSC 3.0 exciter RF 2. The STLTP fronthaul 513 is immediately sent over IP network to ATSC 3.0 exciter RF 2.

The LDM core layer signal 514 and enhanced layer signal 515 enter LDM processing 516 in the exciter of CAF donor RF 2 517 with parameters 412, 413 of FIG. 2, according to some examples. The baseband frame signal is created and converted to RF 2 and broadcast using CAF donor RF 2 517. The RF 2 signal is received with core layer services by UE 518, which is agnostic to the enhanced layer CAF for STLTP.

The RF 2 CAF (STLTP) signal is received at distributed SFN transmitter sites 519 by donor LDM receivers RF 2 and core layer signal is used to recover enhanced layer CAF fronthaul 520 that is input to exciters 528 and core layer is discarded.

Next, provisioning of RF 1 SFN is discussed to create SFN area 521 composed of five SFN transmitters, one SFN RF 1 524 with direct STLTP fronthaul 523 and 4 distributed SFN sites 519 using CAF STLTP broadcast on RF 2 donor 517, according to some aspects.

According to some aspects, the three items to create a broadcast SFN topology are that the transmitters use same frequency and emit same data or symbols at the same time to become coherent at the receivers UE 521. In this example, the same frequency and same symbols of the scheduler are assumed. Now measuring and adjusting the same time of emission at SFN transmit antennas 532, 533 is discussed.

In real world, small offsets in time in microseconds between emissions of SFN transmitters can be used to optimize SFN service area. At the speed of light, a RF signal travels 1 foot in 1 nanosecond. However, zero time offsets between SFN transmitter antennas are used for this initial discussion. How time offsets can be achieved in SFN provisioning is discussed below.

In system 500, a manual SFN provisioning process by an engineering person is described, according to some aspects. Then, full automation of SFN provisioning and monitoring is discussed with respect to FIG. 8 using eCPRI cloud method CAF.

The ATSC 3.0 SFN timing A/324 (STLTP) uses International Atomic Time (TAI) time, which is available using GPS at transmitter sites 517, 524, 532, and/or PTP 503 at ATSC 3.0 gateways. The TAI is monotonically increasing (no leaps seconds) from a known Epoch. Each ATSC 3.0 frame starts with a A/321 bootstrap symbol. The emission time bootstrap symbol at the air interfaces of antennas 533, 532 is assigned by scheduler 501. The A/324 scheduler uses 32 bits seconds and 32 bits nanoseconds in timestamp sent in a timing and management packet 506 to signal emission time of the A/321 bootstrap symbol.

According to some aspects, the ATSC 3.0 gateway uses PTP as a source of the TAI time. The ATSC 3.0 exciters can use either PTP or GPS as the source of the TAI. With all entities (e.g., the gateways, the exciters, etc.) using the same time reference (e.g., TAI), the ATSC 3.0 gateway 501 can confidently establish a bootstrap emission time for each ATSC 3.0 frame RF1 SFN. In one example, the delays of all STLTP fronthaul paths to all RF1 SFN exciters are known by system manager 504 and/or scheduler 501.

In step (1) of manual provisioning, an engineering person 525 enters SFN design parameters and interacts with system manager 504 to provision SFN using A/324, which send commands to each SFN RF 1 transmitter assigned a unique transmission identifier (TXID). The system manager 504 instructs scheduler 501, which has PTP 503 reference to start the provisioning process and scheduler 501 releases a timing and management packet 506 with a time stamp indicating release time of packet at step (2) 526 at output STLTP Mux 507. The STLTP buffer 522 (which will be used as a compensating delay) is first set to zero delay to start SFN provisioning process and timing and management packet 526 propagates over fronthaul 523 to STLTP Demux in ATSC 3.0 exciter RF 1 of SFN 524.

Then, in step (3) 527 the timing and management packet 526 is received at the instant observed using GPS time reference at 527. The instant timing and management packet 526 is received 527 minus the value of timestamp carried in packet indicating instant released step (2) is the actual delay time measured and will become part of provisioning process to be discussed.

The STLTP CAF 508 is also simultaneously sent as LDM enhanced layer on RF 2 517 and is broadcast to distributed SFN sites 519 and LDM enhanced layer STLTP CAF is recovered LDM receivers and input 520 ATSC 3.0 exciters as previously discussed.

Then, in step (4) 528, from STLTP demux, timing and management packet 526 is received at instant observed using GPS time reference at 528. The instant timing and management packet 526 is received at 528 minus the value of timestamp carried in timing and management packet 526 indicating instant released step (2) is actual delay time measured for each distributed SFN transmitter at 528 and will become part of provisioning process to be discussed.

In manual provisioning these delay times measured at 527, 528 for each transmitter is sent by some method to step (1). These STLTP fronthaul delay times then become known to system manager 504 and scheduler 501.

At step (5), the timing manager 531 in scheduler 501, knowing the delays of all fronthaul paths, determines the longest delay path to transmitters of RF 1 SFN 524. There is also a STLTP buffer 522 and a buffer 529 in each exciter of RF 1 SFN 524 Step (5) 528 that can be set to achieve a compensating delay to establish emission time of bootstrap that starts each frame emitted.

This bootstrap emission time is calculated by scheduler 501 and then also sent in timing and measurement packet 526 to exciters of SFN RF1 524 as a timestamp TAI indicating the bootstrap emission time SFN transmitter at the air interface of the antenna.

The scheduler 501 sets compensating delay STLTP buffer 522 at step (6) 530 to make gross compensating time delay. Then, each exciter of SFN RF 1 524, using timing and management packet 526 received at 527 and 528, again measures fronthaul delay and then observes bootstrap emission time (TAI) sent using timing and management packet 526. Then exciter adjusts the buffer 529 and buffers of SFN exciters at 528 to achieve emission time indicated by timing and management packet 526 at the air interface of SFN antennas at step (7) 532, and at step (8) 533 and this produces coherent symbols emitted with zero time offsets for 521 to help understand basic SFN concept.

There are other details that can be entered by engineering 525 to optimize provisioning. For example, first each SFN transmitter delay from buffer output at 528, 529 to the antenna air interface is termed transmitter to antenna delay (TAD) assuming RF at speed of light is 1 foot per nanosecond. This value of TAD can be either measured or calculated by engineering for each site and entered by engineering 525.

Also, any designed intentional time offsets from zero for each transmitter can be input by engineering 525 to optimize SFN service area. All values entered 525 would be sent to all transmitters address by unique TXID and used in calculation of buffer size 529, 528.

The scheduler 501 is responsible for SFN timing including sending of CAF STLTP fronthaul RF 2 517. The example CAF donor transmitter parameters LDM 412, 413 of FIG. 4 is one example that gives good spectrum efficiency ˜5 bps/Hz.

As will be discussed with respect to FIG. 8, eCPRI method under full automation and with spectrum sharing resources are accounted under SLA between multiple (e.g., N) BVNOs to enable new business and efficient spectrum utilization. The OFDM resources shared including for donor CAF fronthaul would be accounted and compensated under SLA. This sharing opens new paradigm for monetizing broadcast spectrum termed Broadcast Market Exchange (BMX).

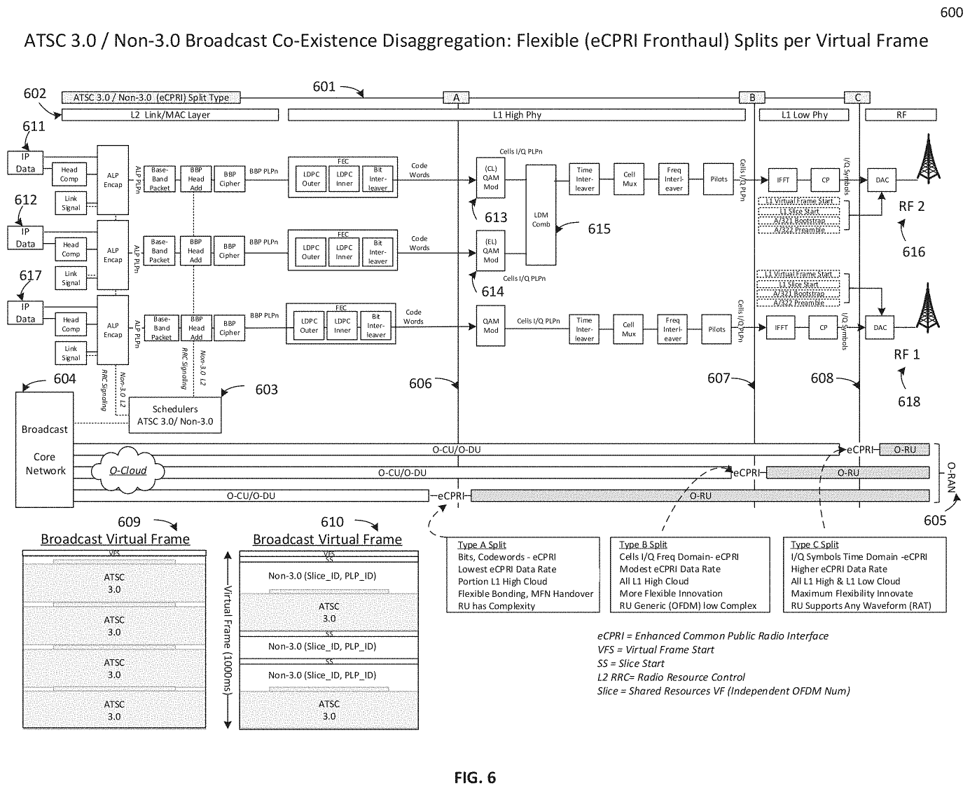

FIG. 6 illustrates system 600 including ATSC 3.0 and Non-3.0 co-existence with dynamic spectrum sharing using eCPRI fronthaul to implement broadcast physical layer, according to some aspects of this disclosure. Aligned with Open RAN cloud principles and providing broadcast slices with a virtual frame reception paradigm for innovation is discussed in U.S. Provisional Patent Application No. 63/306,333 titled “ATSC 3.0 and Non-3.0 Broadcast Co-exist Aligned O-RAN” filed on Feb. 3, 2022.

The disaggregation of broadcast physical layer into flexible splits (A, B, C) for the processing between the cloud 601 and transmitter sites aligned with O-RAN principles 605 is shown in system 600.

This forms basis for eCPRI (CAF) method to be discussed with respect to systems 800 and 1000. After first introducing, eCPRI implementation of broadcast physical layer is discussed, which like A/324 (STLTP) will produce complaint ATSC 3.0 signals. However, eCPRI can enable innovation and automation to be discussed beyond the capabilities of A/324 (STLTP) broadcast physical layer implementation method.

The split of physical layers 602 is shown as is schedulers 603 located in cloud. It can be observed in system 600 that processing to the left of split points (A) 606, (B) 607, (C) 608 is in the cloud which brings flexibility. The broadcast core network 604 is shown aligned with O-RAN 605.

FIG. 6 illustrates exemplary broadcast virtual frames 609, 610 with ATSC 3.0 and Non-3.0 frames, which are optimized for mobile battery powered UE co-existing dual schedulers 603. Orchestrated cloud for sharing of spectrum from multiple (e.g., N) broadcast channels for multiple (e.g., N) broadcast virtual network operators BVNOs will be introduced with respect to FIG. 7.

The IP data input 611, 612 is shown being used by core layer 613 and enhanced layer 614 for LDM combining 615 for RF 2 transmitter 616. The IP data 617 is used for RF 2 transmitter 618, which could be sent to multiple (e.g., N) SFN transmitters. Those skill in art will appreciate the flexibility inherent in system 600 architecture beyond couple examples given.

FIG. 7 illustrates an exemplary block diagram of system 700 using eCPRI for fronthaul to implement ATSC 3.0 and ATSC X.X co-existence of intelligent RAN broadcast physical layer, according to some aspects of this disclosure. In some examples, system 700 is in addition to, or in alternative to A/324 physical layer implementation discussed with respect to FIG. 2.

Functions inside blocks 703, 702, 707 are cloud-native virtual software functions compared to monolithic hardware appliances in system 200 to implement ATSC 3.0. The broadcast implementation of system 700 produces compatible ATSC 3.0 frames and ATSC X.X frames for innovation, and includes spectrum sharing and self-organizing network (SON) automation functions aligned O-RAN to provision SFN as will be discussed with respect to system 800 of FIG. 8.

There is shown in broadcast virtual network operators (BVNOs) 701 using northbound interface 702 shown for sharing spectrum resources of multiple (e.g., N) carriers in spectrum pool 718 and with shared a broadcast core.

The physical layer disaggregation is shown inside block 703 aligned with O-RAN principles O-CU 704 and O-DU L1 High 705 and then via eCPRI fronthaul 711 and IP network 712 with L1 low O-RU 713 at the transmitter site.

The dual schedulers (ATSC 3.0 and ATSC X.X) 706 are shown aligned with O-RAN intelligence system 707, and will be discussed with respect to system 800 of FIG. 8 for self-organizing network (SON) automation for SFN. The disaggregation split type A 708, 714 and type B 709, 715 and type C 710, 716 equivalent (606, 607, 608) are indicated and the broadcast frame is then converted in O-RU 713 to RF (N) 717.

FIG. 8 illustrates a block diagram of system 800 implementing an example of intelligent RAN eCPRI method CAF using LDM with CAF donor transmitter RF 2 for providing fronthaul for SFN densification on RF1 with automated provisioning, according to some aspects of this disclosure. In some examples, system 800 is in addition to, or in alternative to the A/324 method CAF using LDM with manual provisioning system 500.

The BVNOs 801 are shown accessing the northbound interface of block 802, which is a cloud aligned with O-RAN cloud-native principles with functions in software.

The O-RAN aligned O-CU 803 layer 2 and O-DU 804 layer 1 (High) in block 802 and O-RU RF 2 811 and O-RU RF 1 823 and ATSC RU 830 shown located at the broadcast transmitter sites use either eCPRI 822 or eCPRI 810 fronthaul from block 802 as will be discussed to enable SFN densification RF 1 820.

The spectrum resource manager (SRM) 805 is software function for managing spectrum pool under BMX orchestration. SRM 805 communicates in real-time with the schedulers 806, 807 at L2 MAC layer to efficiently use spectrum resources dynamically. The IP data content from BVNOs 801 is shown exiting shared broadcast core network 838 and is input to ALP controlled by schedulers 806, 807.

The L2 layer (O-CU) and Layer 1 high (O-DU) are processed for data PLP shown and are input to eCPRI (eREC) 836 for multiplexing along with control timing and management 834 generated by schedulers 806. The eCPRI fronthaul 822 is sent to O-RU RF1 823 after eCPRI buffer 821 sets compensation delay and then buffer 829 sets compensating delay 823 is broadcast 824 as coherent SFN signal to support SFN densification 820.

The second output of eCPRI (eREC) 836 is CAF eCPRI 808 sent as enhanced layer (LDM) to ALP input controlled by schedulers 807 for donor RF 2 815. The L2 layer (O-CU) and (O-DU) Layer 1 high are processed for data content PLP shown is input to eCPRI (eREC) 837 for multiplexing along with control timing and management 835 generated by schedulers 807 for eCPRI fronthaul 810 and O-RU RF 2 donor.

The eCPRI fronthaul 810 is sent via IP network to eCPRI (eRE) demux in O-RU RF 2 811. The core layer 812 and enhanced layer 813 are input LDM 814 in donor 811, where the frame is processed, converted to RF, and broadcast using RF 2 donor 815. The broadcast from RF 2 815 is received as independent services core layer by UE 816, which is agnostic to LDM in the broadcast.

The CAF eCPRI 817 broadcast from RF 2 donor 815 is received by the LDM receivers 300, 400 at distributed SFN sites 818 and enhanced layer 813 eCPRI fronthaul 819 is recovered and is input to ATSC RU 830 at the distributed SFN RF1 sites.

Next, the self-organizing network (SON) 828 functionality using 0-RAN intelligence system 825 for provision of broadcast SFN in system 800 using automation is discussed, and then automation is presented aligned with O-RAN principles for broadcast.

A self-organizing network (SON) is automation technology designed to make the planning, configuration, management, optimization and healing of mobile networks simpler and faster. The SON functionality and behavior has been defined and specified in accepted mobile industry recommendations produced by organizations such as 3GPP (3rd Generation Partnership Project) including emerging 5G and the O-RAN alliance using cloud automation for the RAN.

System 800 is aligned for broadcast SEN provisioning and automation using methods disclosed including by a simple walkthrough of provisioning SFN to increase understanding of those skilled in the art.

The O-RAN intelligence system 825 includes Service Management Orchestration (SMO) that provides Non-Real-time RAN Intelligent Control (MC) connected to Spectrum Sharing 805 and BMX orchestration.

The Near Real-time (RIC) 827 interacts via A1 interface 839 with SMO for policy guidance. The intelligence RIC 827 and E2 interface enables interaction in near real-time with schedulers 806, 807, O-CU 803, and O-DU 804 of broadcast physical layer in cloud 802. Moreover, O1 interface 833 interacts with O-RU 811, 823 and RU 830 at transmitter sites and collectively enables closed loop automation with artificial intelligence (AI) and SON rAPP running on SMO to provision and manage broadcast SFN 800.

The provisioning of SFN using automation is now discussed and this can be compared and contrasted with system 500 manual SFN provisioning. The PTP 841 and GPS at RUs 811, 823, 830 provide common time reference of TAI used for SFN.

A brief walkthrough of 10 steps for automated provisioning of SFN using principles Self-Organizing Network (SON) is discussed below using system 800.

Step (1) Engineers enter input SFN design parameters 826 into automation platform;
Step (2) SFN parameters sent to SMO Non-Real-Time (RIC) with SON rAPP;
Step (3) SFN parameters sent via A1 interface 839 and stored at RAN Topo database (DB) 827;
Step (4) SON rAPP via O1 interface directs schedulers 806 to start SFN provisioning;
Step (5) One-way timing measurement packet 834 released by eCPRI fronthaul 822, 810;
Step (6) eCPRI delay measurements at RUs 823 and 830 sent via O1 interface 833 to SON 828;
Step (7) SON 828 calculates buffer 821, bootstrap emission time and scheduler 806 sends packet 834;
Step (8) Buffers 821, 829 at O-RU 823, and 830 compensate for delays set;
Step (9) Another packet 834 is sent for delay measurement with bootstrap emission time;
Step (10) SON 828 via O1 interface 833 verifies timing SFN entered (1) achieved switches to monitoring.

At Step (1), engineering has designed the SFN and enters design parameters 826 to provision SFN. Design parameters 826 also includes transmitter to antenna delay (TAD) and any +/− timing offsets for each site to be used in calculating compensating delays in buffers 829 at O-RU 823 and RU 830 to optimize SFN design.

At Step (2), using interface from BMX orchestration 805, the design configuration parameters are sent to SMO with SON rAPP running used to automate provisioning.

At Step (3), the SMO sends SFN configuration parameters via interface A1 839 and the parameters are stored at database 827 in RAN topology database.

At Step (4), the SMO with SON rAPP running under AI communicates via O1 interface 833 to schedulers 806 and requests SFN provision procedure start.

At Step (5), schedulers release one-way timing measurement packet 834, which contains exact release time of measurement packet output eCPRI (eREC) 836. The eCPRI buffer 821 is set to zero delay and eCPRI fronthaul 822 is sent to O-RU 823 RF 1.

The CAF eCPRI 808 is sent using enhanced layer LDM eCPRI (eREC) 837 in the eCPRI fronthaul 810 to O-RU RF 2 811. The broadcast donor RF 2 815 broadcast CAF eCPRI 817, which is received at distributed SFN sites 818. The LDM receivers recover fronthaul 819 and input fronthaul 819 to RU at all distributed SFN sites RF 1 RU 830.

At Step (6), using time measurement packet 834 sent using 0-RU RF 1 823 to all distributed SFN sites RF 1 of RUs 830 is used. The time of arrival of time measurement packet 834 is observed using GPS at O-RU RF 1 823 and at RUs 830, and each measured delay value is determined and is sent to SON in SMO 828 via O1 interface 833.

At Step (7), SON 828 knowing the measured delays of all eCPRI fronthaul including the longest delay path, SON 828 calculates eCPRI buffer compensating delay 821. SON 828 calculates the bootstrap emission time for start of frame at the air interface of antennas SFN 1 831, 832. Then via O1 interface 833, schedulers 806 release another timing and measurement packet 834 including bootstrap emission time.

At Step (8), the eCPRI buffer 821 compensating delay is set. Then with packet 834 and parameters (TAD, time offset) entered at Step (1) received at O-RU 823 and RU 830, the RU calculates buffer 829 and buffers in all RU 830 to enable the bootstrap emission time air interfaces 831, 832 calculated SON 828.

At Step (9), SON 828 via O1 interface 833 has schedulers 806 release another timing and measurement packet 834 including at eCPRI (eREC) and is sent again over eCPRI fronthaul 822 to O-RU 823 and over eCPRI fronthaul 810 to RU 830. The RU calculates buffer 829 and buffers in all RU 830 to enable the bootstrap emission time air interfaces 831, 832 and measurements of timing are made and sent via O1 interface 833 to SON 828.

At Step (10), SON 828 verifies the SFN has been provisioned to parameters entered at Step (1) and via O1 interface 833, and informs schedulers 806 that SFN provisioning is complete.

The SFN produces coherent symbols in SFN service area 820 and is in service and SON 828 enters a monitoring of SFN to ensure compliance to provisioning. This makes planning, configuration, management, optimization and healing of mobile networks simpler and faster and reacts if events occur.

In some aspects of this disclosure, a first scheduler 806 can be configured to receive an input packet (from, for example, broadcast core 838) and generate a first packet to be transmitted using a first radio unit (RU) 823. A person of ordinary skill in the art would understand that a packet is a collection bits (1's and 0's) representing control and/or data bits. A second scheduler 807 can be configured to receive the first packet from the first scheduler 806 (e.g., through CAF eCPRI 808) and generate a second packet. The second packet is to be transmitted using a second RU 811. A first fronthaul 822 operated using evolved Common Public Radio Interface (eCPRI) protocol is configured to direct the first packet to the first RU 823 to be transmitted on a first channel having a first frequency (e.g., RF 1). A second fronthaul 810 operated using the eCPRI protocol can be configured to direct the second packet to the second RU 811 to be transmitted on a second channel having a second frequency (e.g., RF2) different from the first frequency.

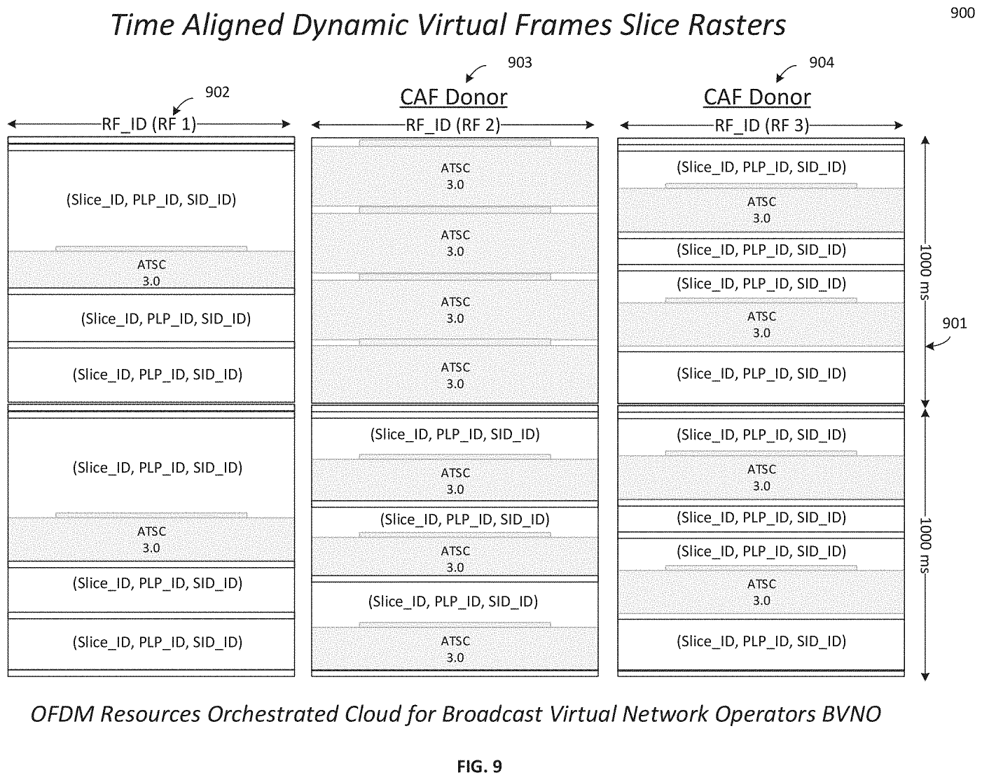

FIG. 9 illustrates broadcast virtual frames 900 introduced by frames 609, 610 with flexibilities for SFN densification using two CAF donor 903 RF 2 and CAF donor 904 RF 3 to support SFN densification 902 RF 1, according to some aspects of this disclosure.

According to some examples, all virtual broadcast frames are time aligned have a duration of about 1000 ms giving automation to system 800 and BVNOs 801 sharing spectrum resources BMX 805. However, the aspects of this disclosure can include other frame duration. This example provides more flexibility to enable CAF eCPRI fronthaul using two donor RF 2 and RF 3 dynamically for establishing shared SFN densification on RF 1 as business model BMX with all resources accounted under SLA. This flexibility will be discussed with respect to system 1000 of FIG. 10, and then for SFN densification example use case examples 1100, 1200, 1300.

FIG. 10 illustrates a block diagram of system 1000 implementing an example of intelligent RAN CAF eCPRI method using LDM on CAF Donor transmitter RF 2 and RF 3 for providing eCPRI fronthaul SFN densification on RF 1, according to some aspects of this disclosure.

The flexibility of virtual broadcast frames 900 is the 1000 ms duration 901 composed of multiple (e.g., N) broadcast slices each being multiple (e.g., N) milliseconds in duration, using schedulers 1003 in cloud for RF 1, RF 2, RF 3. This means total resources for CAF eCPRI fronthaul can be from combination of donor RF2 and donor RF 3 resources (LDM). The cloud schedulers 1003 working with automation and BMX 1002 can flexibly change resource on 1000 ms boundary.

System 1000 shows inclusion of donor RF 2 1017 and donor RF 3 1010 under RAN intelligence 1031, SMO 1032 with SON rAPP and Near Real-time (RIC) 1030, and RAN topology database. System 1000 also includes interfaces A1, E2, and O1 1029 discussed in 900.

According to some aspects, using two donors RF2 and RF 3 provides the flexibility. However, the automation including engineering input 1037 will function the same or similar to provisioning SFN of RF1 as discussed with respect to system 800 of FIG. 8 using single CAF donor.

According to some aspects, system 1000 provides the flexibility of having two donors RF 2 CAF eCPRI 1021 and RF 3 CAF eCPRI 1014 providing the fronthaul to distributed SFN sites RF 1 1022.

The cloud 1001 has software functions including 0-CU and O-DU previously discussed with respect to system 800 and also includes spectrum resource manager entity 1002. There are now three schedulers 1003 which also provide time and management packets like packets 834, 835 of FIG. 8 (not shown in FIG. 10). The IP data content 1004, 1007, 1008 from BVNO is shown exiting a broadcast core entering ALP input controlled by schedulers 1003.

There are two CAF eCPRI outputs 1005, 1006 of eCPRI (eREC) before eCPRI buffer 1025 that include timing and management packets enhanced layer LDM. FIG. 10 also illustrates two associated eCPRI fronthaul 1016, 1009. FIG. 10 illustrates eCPRI fronthaul RF 2 1016 to O-RU 1017 with core layer 1018 and enhanced layer 1019 LDM, which is broadcast RF 2 donor for core services 1020, and CAF eCPRI 1021 to distributed SFN sites RF 1 1022. FIG. 10 also illustrates eCPRI fronthaul RF 3 1009 to O-RU 1010 with core layer 1011 and enhanced layer 1012 LDM, which is broadcast RF 3 donor for core services 1013 and CAF eCPRI 1014 to distributed SFN sites RF 1 1022.

Using two donors, the fronthaul 1023 is recovered at 1022 and is input to RU RF 1 1034. The SON automation works the same as or similar to system 800, and eCPRI buffer 1025 and buffer 1033 and at RU 1034 are set and calculated using closed loop automation via interface O1 1029 and SON 1032 as discussed in more detail above with respect to FIG. 8. This is to ensure bootstrap emission time 1035, 1036 at air interfaces antennas SFN densification RF 1.

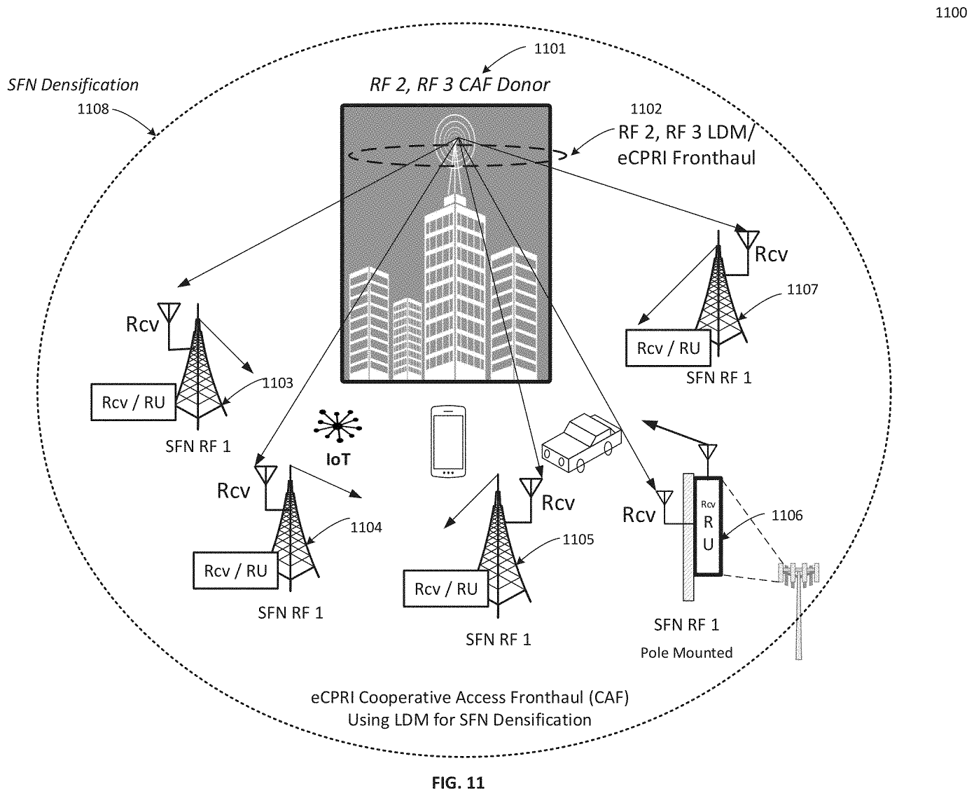

FIG. 11 illustrates an exemplary use case system 1100 for SFN densification in geographic area 1108 using intelligent RAN eCPRI method CAF using LDM on CAF donor transmitters RF 2 and RF 3 1101 for providing fronthaul SFN densification on RF 1, according to some aspects of this disclosure.

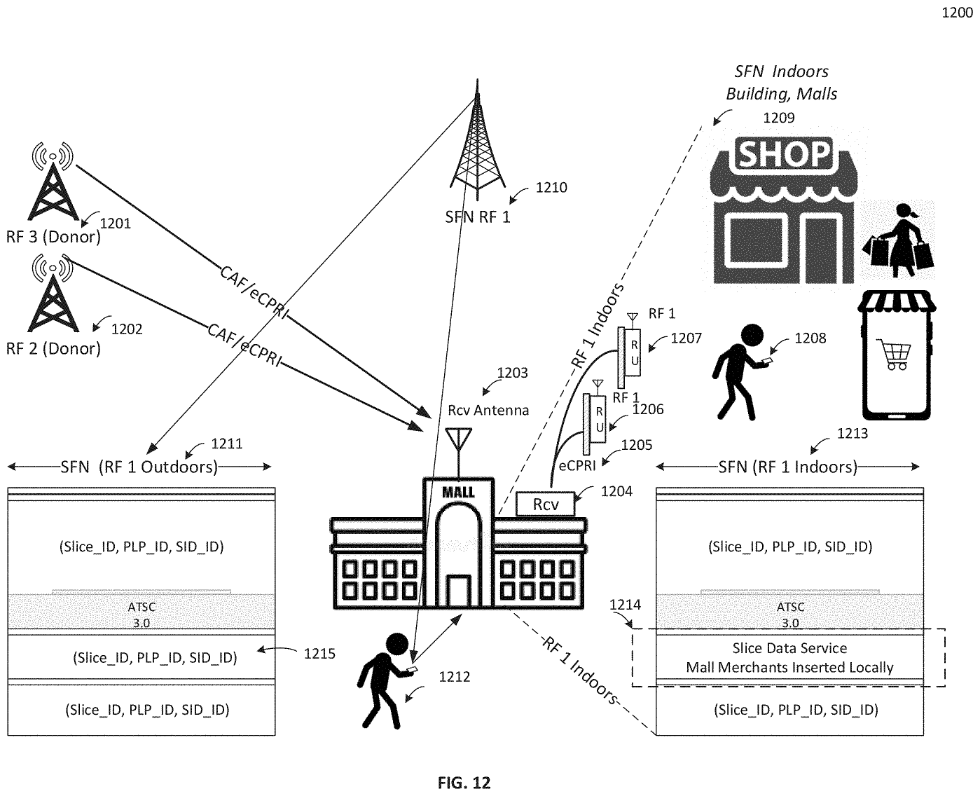

The height and transmit power of donor transmitters 1101 enables CAF eCPRI LDM signal to be received over a wide geographic area 1108. There are four SFN RF 1 sites 1103, 1104, 1105,1107 shown with receive antennas mounted on the towers for LDM receivers with RU and GPS located at base of tower. The SFN RF 1 site 1106 has LDM receiver RU with GPS in an enclosure pole mounted shown on cell tower which can be easily located including indoors as discussed with respect to FIG. 12.

Though five SFN transmitter are shown in geographic area 1108, this example can be densified with any number of locations able to receive RF 2 LDM, RF 3 LDM, and/or eCPRI fronthaul 1102 broadcast from CAF donor transmitters RF 2 and RF 3 1101. Each site under SON automation would be provisioned to enable SFN coherent symbols entered to provision and then switch to operation and monitoring.

FIG. 12 illustrates an exemplary use case system 1200 for SFN densification outdoors and indoors using SFN RF 1 such as at a Mall or other venue with pedestrian traffic that can use broadcast content or data services, according to some aspects of this disclosure.

The RF 3 donor 1201 and RF 2 donor 1202 broadcast CAF eCPRI as discussed with respect to system 1000 to a roof mounted receive antenna 1203 connected to receivers 1204 to recover eCPRI fronthaul 1205 to pole mounted RU SFN RF 1 transmitters 1206, 1207 located strategically located inside mall 1209.

There is an outdoor SFN RF1 transmitter 1210 broadcasting as discussed with respect to system 1000. The virtual frame RF 1 outdoors SFN 1211 can be received by, for example, pedestrians about to enter the mall 1212.

Once the pedestrian 1208 is inside the mall, they continue to receive IP content data on densified indoor using frame RF 1 indoors SFN 1213 as shown. Most broadcast slice services are identical on frames 1211 and 1213, so, for example, the game the consumer was watching outdoors can continue indoors. According to some examples, one difference is that inside the mall a new data slice service 1214 is being sold to mall merchants and is inserted locally at mall 1209 to engage consumers. The robustness of data slice service 1214 is adjusted to ensure reliable indoor service and the outdoor slice 1215 is different and would only be available outdoors.

The return communications link for the O1 interface 1029 and SON 1032 automation from RU is not shown but is low bandwidth and can be provided by internet on site and or cellular, etc. The cost to deploy inside SFN densification using low power transmitters is modest and would complement outdoor service and open new revenue indoors with continued broadcast services.

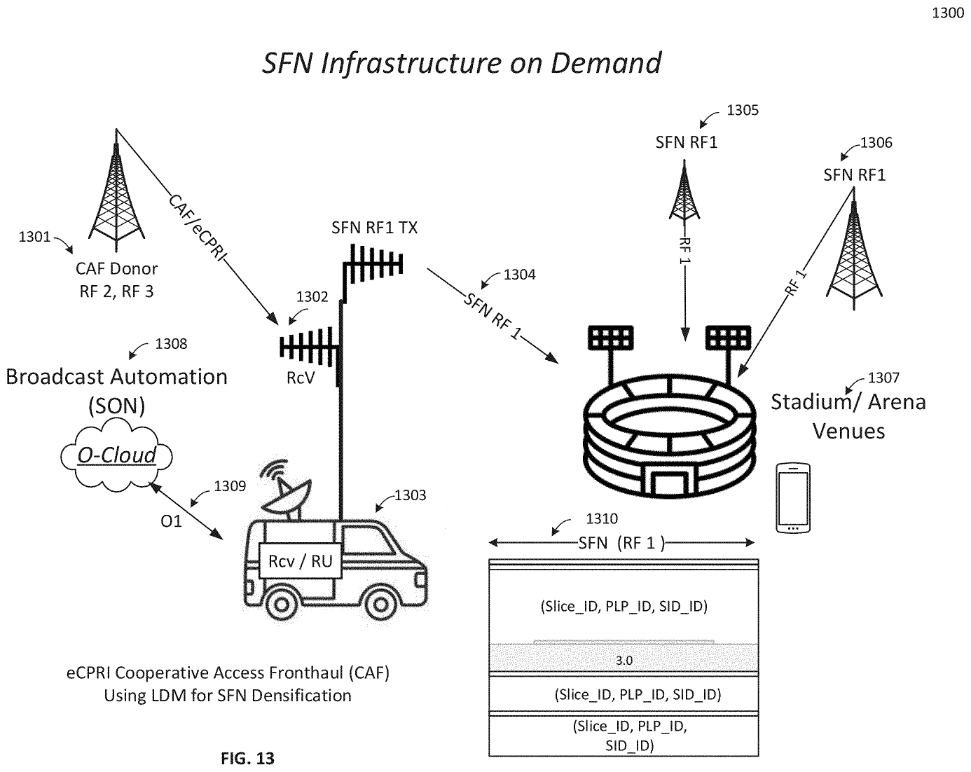

FIG. 13 illustrates an exemplary use case system 1300 for SFN densification of outdoors SFN infrastructure on demand model at a stadium 1307 or other venues with large consumer attendance that can use broadcast services, according to some aspects of this disclosure.

System 1300 shows two permanent SFN RF1 sites 1305, 1306 located a distance from stadium 1307. To improve service, SFN RF1 1304 is deployed for this event and will improve signal strength at event with coherent symbols enforcing of SFN RF1 sites 1305, 1306 with SFN RF1 frame 1310.

The CAF donor 1301 provides signal coverage over stadium area. A remote broadcast production vehicle 1303 is positioned with elevated mask with receive antenna 1302 for CAF donor 1301 and with LDM receivers and RU with GPS in vehicle 1303. The top of mask is SFN RF1 transmit antenna for broadcasting SFN RF1 1304 into stadium 1307.

Given stadium 1037, the engineering would input SFN parameters including TAD and +/− offsets for each transmitter, which has a unique TXID. The communications link from SON broadcast automation in cloud 1308 using 01 interface 1309 to vehicle 1303 can have low bandwidth and can be established using cellular LTE or 5G during an event at stadium 1307.

Not shown but there could also be permanent SFN RF1 sites installed inside stadium for densification activated under SON automation for the event then shut down. Again the cost of low power SFN densification installed at event is nominal and can be easily justified with the substantial number of consumers in attendance.

Various aspects may be implemented, for example, using one or more processors, computing devices, computer systems. Also or alternatively, one or more computer systems may be used, for example, to implement any of the aspects discussed herein, as well as combinations and sub-combinations thereof.

Any of the various aspects described herein may be realized in any of various forms, e.g., as a computer-implemented method, as a computer-readable memory medium, as a computer system, etc. A system may be realized by one or more custom-designed hardware devices such as Application Specific Integrated Circuits (ASICs), by one or more programmable hardware elements such as Field Programmable Gate Arrays (FPGAs), by one or more processors executing stored program instructions, or by any combination of the foregoing.

In some aspects, a non-transitory computer-readable memory medium may be configured so that it stores program instructions and/or data, where the program instructions, if executed by a computer system, cause the computer system to perform a method, e.g., any of the method aspects described herein, or, any combination of the method aspects described herein, or, any subset of any of the method aspects described herein, or, any combination of such subsets.

In some aspects, a computer system may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The computer system may be realized in any of various forms. For example, the computer system may be a personal computer (in any of its various realizations), a workstation, a computer on a card, an application-specific computer in a box, a server computer, a client computer, a hand-held device, a mobile device, a wearable computer, a sensing device, a television, a video acquisition device, a computer embedded in a living organism, etc. The computer system may include one or more display devices. Any of the various computational results disclosed herein may be displayed via a display device or otherwise presented as output via a user interface device.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A system, comprising:
a first scheduler configured to receive an input packet and generate a first packet based on the input packet;
a second scheduler configured to receive the first packet from the first scheduler and generate a second packet based on the first packet;
a first fronthaul operated using evolved Common Public Radio Interface (eCPRI) protocol and configured to direct the first packet to a first radio unit (RU) to be transmitted on a first channel having a first frequency; and
a second fronthaul operated using the eCPRI protocol and configured to direct the second packet to a second RU to be transmitted on a second channel having a second frequency different from the first frequency.

2. The system of claim 1, wherein the second RU is configured to transmit the second packet over an enhanced layer of a layer division multiplexed (LDM) packet.

3. The system of claim 1, further comprising:
a third scheduler configured to receive the first packet from the first scheduler and generate a third packet based on the first packet; and
a third fronthaul operated using the eCPRI protocol and configured to direct the third packet to a third RU to be transmitted on a third channel having a third frequency different from the first frequency and the second frequency.

4. The system of claim 3, wherein the third RU is configured to transmit the third packet over the enhanced layer of a second LDM packet.

5. The system of claim 3, wherein:
the second scheduler is configured to use a first portion of the first packet to generate the second packet; and
the third scheduler is configured to use a second portion of the first packet to generate the third packet.

6. The system of claim 1, wherein the first and second schedulers are part of a cloud aligned with Open Radio Access Network (O-RAN) cloud-native principles.

7. The system of claim 6, further comprising:
a plurality of Single Frequency Network (SFNs); and
an O-RAN intelligence system configured to automate provision of the plurality of SFNs.

8. The system of claim 7, wherein the O-RAN intelligence system further comprises a Self-Organizing Network (SON), a Service Management Orchestration (SMO), and a Non-Real-time RAN Intelligent Control (MC).

9. The system of claim 7, further comprising:
an automation platform configured to receive one or more design parameters associated to the plurality of SFNs and configured to send the one or more design parameters to the O-RAN intelligence system, wherein:
the SON is configured to direct the first scheduler to start SFN provisioning, and
the first scheduler is configured to generate and transmit a one-way timing measurement packet using the first and second fronthauls.

10. A non-transitory computer-readable medium includes instructions stored thereon that, when executed by at least one computing device, cause the at least one computing device to perform operations comprising:
receiving, using a first scheduler, an input packet;
generating, using the first scheduler, a first packet based on the input packet;
receiving, using a second scheduler, the first packet from the first scheduler;
generating, using the second scheduler, a second packet based on the first packet;
directing, using a first fronthaul operated using evolved Common Public Radio Interface (eCPRI) protocol, the first packet to a first radio unit (RU) to be transmitted on a first channel having a first frequency; and
directing, using a second fronthaul operated using the eCPRI protocol, the second packet to a second RU to be transmitted on a second channel having a second frequency different from the first frequency.

11. The non-transitory computer-readable medium of claim 10, wherein the operations further comprising transmitting, using the second RU, the second packet over an enhanced layer of a layer division multiplexed (LDM) packet.

12. The non-transitory computer-readable medium of claim 10, wherein the operations further comprising:
receiving, using a third scheduler, the first packet from the first scheduler;
generating, using the third scheduler, a third packet based on the first packet; and
directing, using a third fronthaul operated using the eCPRI protocol, the third packet to a third RU to be transmitted on a third channel having a third frequency different from the first frequency and the second frequency.

13. The non-transitory computer-readable medium of claim 12, wherein the operations further comprising transmitting, using the third RU, the third packet over the enhanced layer of a second LDM packet.

14. The non-transitory computer-readable medium of claim 12, wherein the operations further comprising:
using a first portion of the first packet to generate the second packet; and
using a second portion of the first packet to generate the third packet.

15. The non-transitory computer-readable medium of claim 10, wherein the first and second schedulers are part of a cloud aligned with Open Radio Access Network (O-RAN) cloud-native principles.

16. The non-transitory computer-readable medium of claim 15, further comprising:
automatically provisioning, using an O-RAN intelligence system, a plurality of Single Frequency Network (SFNs).

17. The non-transitory computer-readable medium of claim 16, wherein the O-RAN intelligence system comprises a Self-Organizing Network (SON), a Service Management Orchestration (SMO), and a Non-Real-time RAN Intelligent Control (MC).

18. The non-transitory computer-readable medium of claim 16, wherein the operations further comprising:
receiving, using an automation platform, one or more design parameters associated to the plurality of SFNs; and
sending the one or more design parameters to the O-RAN intelligence system, wherein:
the SON is configured to direct the first scheduler to start SFN provisioning, and
the first scheduler is configured to generate and transmit a one-way timing measurement packet using the first and second fronthauls.

19. A system, comprising:
a first Advanced Television Systems Committee (ATSC) scheduler configured to receive an input packet and generate a first packet based on the input packet;
a second ATSC scheduler configured to receive the first packet from the first ATSC scheduler and generate a second packet based on the first packet;
a first Studio to Transmitter Link Transport Protocol (STLTP) fronthaul configured to direct the first packet to a first ATSC exciter to be transmitted on a first channel having a first frequency; and
a second STLTP fronthaul configured to direct the second packet to a second ATSC exciter to be transmitted on a second channel having a second frequency different from the first frequency.

20. The system of claim 19, wherein the second ATSC exciter is configured to transmit the second packet over an enhanced layer of a layer division multiplexed (LDM) packet.
